(19) United States
(12) Patent Application Publication
(10) Pub. No.: US 2024/0002289 A1
(43) Pub. Date: Jan. 4, 2024

(54) A LOW-CARBON CEMENT AND ITS METHOD OF PRODUCTION

(71) Applicant: SECIL-COMPANHIA GERAL DE CAL E CIMENTO, S.A., Lisboa (PT)

(72) Inventors: João Manuel CORREIA SALVA, Lisboa (PT); Ângela Maria Jesus De Sequeira Serra Nunes, Azeitao (PT)

(21) Appl. No.: 18/037,576

(22) PCT Filed: Nov. 10, 2021
(86) PCT No.: PCT/IB2021/060443

§ 371 Date: May 18, 2023

(30) Foreign Application Priority Data
Nov. 18, 2020 (PT) 116889

(51) Int. Cl. C04B 11/30; C04B 7/47; C04B 7/02; C04B 28/04; C04B 28/14; C04B 28/10; C04B 14/10

(52) U.S. Cl. CPC C04B 11/30; C04B 7/47; C04B 7/02; C04B 28/04; C04B 28/14; C04B 28/105; C04B 14/10

(57) ABSTRACT

The present invention falls within the field of building materials, particularly in the production of cement. It is specifically referred to the production of a cement which is obtained from a low-carbon clinker. The present invention provides a development in cement production with respect to the known cements, thus obtaining a cement with low greenhouse gases emissions, reducing the specific heat consumption and increasing chemical resistance, while maintaining all its functional properties.

### FIELD OF THE INVENTION

The present invention falls within the field of building materials, particularly in the production of cement. It is specifically referred to the production of a cement which is obtained from a low-carbon clinker. The present invention provides a development in cement production with respect to the known cements, thus obtaining a cement with low greenhouse gases emissions, reducing the specific heat consumption and increasing chemical resistance, while maintaining all its functional properties.

### PRIOR ART

The present invention seeks to obtain a cement which allows to recover energy from the process while maintaining a high functionality as a cement.

It therefore enhances the solution of EP 3 070 064, which discloses the production of a low-carbon clinker, which allows to recover energy from the production process, which would otherwise be lost.

### SUMMARY OF THE INVENTION

It is therefore an object of the present invention a method for producing a low-carbon cement which comprises the following steps.
obtaining a low-carbon clinker, the low-carbon clinker being obtained by the following steps:
   i. for a raw material comprising limestone, pre-calcination of such limestone in the raw material;
   ii. start of a clinkering process with a pre-calcined raw material, thereby obtaining an intermediate material;
   iii. cooling the intermediate material;
   iv. introduction of silico-aluminous materials and mixing with the intermediate material at a cooler head, such introduction being performed by a dosing conveyor and buffered by a double-inlet valve, and
thereby obtaining a low-carbon clinker,
   adding the obtained low-carbon clinker in a concentration of 5-95% weight/weight (w/w) to calcium sulphate, thereby obtaining the low-carbon cement.

Such solution therefore provides for a reduced usage of clinker, while still allowing to obtain a fully-functional cement, which provides for a reduction of the used energy as it introduces silico-aluminous materials in the last stage of the production of clinker. Thus, that may reduce the content of added silico-aluminous materials to be subsequently added, as the buffering with a double-inlet valve allows to minimise heat loss and air infiltration (false air) in the low-carbon clinker. Thus, the present solution allows—as the prior art—to recover energy from the production process, which would otherwise be lost, while also maintaining a high functionality of the obtained cement. The addition of the low-carbon clinker to calcium sulphate may also be described as a mixture of the two low-carbon cement components. The addition of calcium sulphate provides for an enhanced regulation of the setting of the low-carbon cement, which would otherwise quickly set. Advantageously, the calcium sulphate is present in a proportion of 0.1-10% w/w. More advantageously, the proportion of calcium sulphate is of 0.1-5% w/w. In the preferred option, the proportion of calcium sulphate is of 0.1-3% w/w. or 0.5-3% w/w. The proportion of calcium sulphate provides for an adequate regulation regarding the proportion of C3A (tri-calcium aluminate) in the low-carbon clinker, where otherwise the cement would instantaneously set. As such low-carbon clinker is more prone to having a low proportion of C3A, a proportion lower than a regular Portland clinker, the presence of calcium sulphate is therefore inventively within the referred range. It is relevant to stress that the low-carbon clinker which is a component of the low-carbon cement of the present invention is obtained through a procedure which makes use of energy resultant from such production process, and thereby may have a reduced content of C3A as regards regular a Portland clinker. The addition of calcium sulphate, when combined with the C3A present in the low-carbon clinker, thereby forms a gel which regulates the setting of the cement, which thereby is stabilized. The addition of calcium sulphate may be performed when of a milling of the cement.

It is also an object of the present invention a low-carbon cement obtained by the method of the present invention, in any of the embodiments of the method described in the present disclosure.

### DESCRIPTION OF FIGURES

FIG. 1—representation of an embodiment of a part of the method of the present invention, in particular referring to the preparation of the low-carbon clinker,

FIG. 2—the same representation of FIG. 1, with the additional indication of the positioning of the silico-aluminous material inlet, leading to an energy saving.

FIG. 3—a representation of the method of the present invention.

### DETAILED DESCRIPTION

The more general and advantageous configurations of the present invention are described in the Summary of the invention. Such configurations are detailed below in accordance with other advantageous and/or preferred embodiments of implementation of the present invention.

In an embodiment of the method of the present invention, it further comprises the addition of at least one additional component to the low-carbon clinker and calcium sulphate, wherein:
the at least one additional component comprises a pozzolanic material, a carbonate component, a blast furnace slag, silica fume, burnt shale and/or their combinations.

Advantageously, the additional component comprises a pozzolanic material, the pozzolanic material consisting of fly ash, calcined clay (preferably natural calcined clay) or other natural or artificial silica-aluminous material. The calcined clay may be obtained through a dedicated calcination, and it is provided in the cement of the present invention to obtain a type of cement which requires a higher proportion of calcined clay. Such solution improves the method of the present invention, as the low-carbon clinker which is a component of the low-carbon cement of the present invention is obtained through a procedure which makes use of energy resultant from such production process, and thereby—despite the fact that it brings calcined clay into the cement and obtained through a procedure with reduced energy consumption—it could result in reduced content of calcined clay as regards the preparation of a regular Portland clinker. Therefore, the addition of calcined clay, particularly in a percentage of 5-35% w/w, more preferably 5-20% w/w or 20-35% w/w.

In an embodiment, the low-carbon clinker is added in a concentration of 5-95%, more preferably 5-20% w/w, 20-50% w/w, 50-70% w/w or 70-95% w/w. Several specific embodiments are described below.

In an inventive aspect of the method of the present invention, the additional component is added in a concentration of 6-94% w/w.

In an embodiment, the method of the present invention further comprises the addition of Portland clinker to the low-carbon clinker and the at least one additional component.

As referred, the additional component may comprise one or more of several elements.

In another inventive aspect of the method of the present invention, combinable with any above described, the additional component comprises a carbonate component, optionally consisting of a natural material, a waste product or a combination thereof. In an embodiment, the carbonate component consists of limestone, magnesium carbonate, calcium magnesium carbonate or combinations thereof. Advantageously, the carbonate component is present in a concentration of 0.1-30% w/w, more preferably 10-20% w/w. The referred waste product as properties similar to those of a natural material.

As referred, in an embodiment the additional component comprises a pozzolanic material, the pozzolanic material consisting of fly ash, calcined clay, bottom ash, another natural or artificial silica-aluminous material or combinations thereof.

Furthermore, in an embodiment of the method of the present invention, the additional component may comprise a fly ash, the fly ash consisting of siliceous or limestone-based fly ash.

Furthermore, in an embodiment of the method of the present invention, the additional component may further comprise the addition of an additional inorganic mineral to the low-carbon clinker and to the additional component, the additional inorganic mineral comprising an additive, such as a pigment or an activator, the activator consisting of a supplementary alkaline source, wherein it may consist of a residue of another process, for instance based in sodium or potassium.

The activator may comprise strongly alkaline materials, such as sodium hydroxide, potassium hydroxide, calcium hydroxide, calcium oxide, calcium nitrate, potassium nitrate or sodium silicate. The activators thereby comprise strongly alkaline substances, which provide the necessary alkalinity to an efficient reaction of pozzolanic materials. Furthermore, the activator may be added during the grounding stage or after. The activator may be present in a concentration within a range of 0.1-20% w/w, more preferably 0.1-15% w/w.

In an embodiment, the additional inorganic mineral comprises an activator, the activator being added when of the agglomeration of cement.

In another embodiment, the method may further comprise the addition of an additional organic mineral to the low-carbon clinker and to the additional component, the additional organic mineral comprising a grinding aid or an admixture, the grinding aid preferably comprising a tensioactive composition and/or the admixture preferably comprising a plasticizer, a superplasticizer or a retarder.

The activator may comprise gluconates, naphthalenes, polycarboxylates, amines or their combinations. Furthermore, the activator may be added during the grounding stage or after. The activator may be present in a concentration within a range of 0.05-5% w/w, preferably 0.5-2% w/w.

In yet another embodiment of the method of the present invention, the silico-aluminous materials are selected from:
blast furnace slag, clay, marl clays, shale, schist and combinations thereof,
natural pozzolanas, diatomite and processed materials, such as artificial pozzolanas originated from waste or by-products of other industries, for instance fly ash, bottom ash, silica fumes or other by-products, or
combinations thereof.

Furthermore, and as regards step i. of the method of the present invention, the pre-calcination may be performed along a pre-calciner of a cyclone tower.

Furthermore, and as regards step ii. of the method of the present invention, such step may be performed at a temperature higher than 1400° C. and with a C3S content above 60%.

Furthermore, and as regards step iv. of the method of the present invention, the silico-aluminous materials may be introduced in 5 to 30% w/w relative to the intermediate material. Thus, the silico-aluminous materials are present in the low-carbon clinker in a concentration of 5-30% w/w.

In an embodiment, advantageously, the cooling of step iii. may consist of an abrupt cooling.

In an embodiment, the raw material which leads to obtaining the low-carbon clinker may comprise pozzolanic materials, such as calcined clay. It may also comprise marl and reduced additions of other components such as silica or iron oxide.

The introduction of silico-aluminous materials when of the preparation of the low-carbon clinker favors the clinker temperature decrease and at the same time promotes a better cooling due to the heat exchanged. These materials can benefit from a calcination processing which is sufficient for its activation, contributing to the presence of a third silicate phase in said mono-silicate based product, whose performance is important regarding its mechanical resistance, especially in the early times, but is mainly distinguished by the chemical resistance.

The method for producing a low-carbon cement and the cement of the present invention therefore benefit from such solution, since performing a co-processing in this point of the method allows to advantage of the heat exchanged with the clinker by using it in a sintering process of the additional material, which is completely inert, such as clays or shale, and thus simultaneously favoring the material cooling by using thermal energy for its mineralogical rearrangement in order to enhance its reactivity. The sintering process of the additional material now proposed enables very high energy savings by avoiding investments in specific kilns, as is known in the art. This effect is achieved through the last stage of preparation of the low-carbon clinker, i.e. with the introduction of silico-aluminous materials during the cooling stage, which are processed there through low temperature calcination with rearrangement of the microstructure.

The method for producing a low-carbon cement and the cement of the present invention are therefore specially adapted to obtain a low-carbon cement which includes the referred, and enhanced, low-carbon clinker.

In another preferred embodiment the used clay materials have more than 25% potential for reactive silica formation.

The activation temperatures of the processed materials are between 200° C. and 250° C., and the activation temperatures of silico-aluminous materials are between 700° C. and 900° C.

In an aspect of the method of the present invention, the Blaine fineness of the cement is within the range of 2.500 to 12.000 cm²/g, preferably 3.600-5.500 cm²/g. The Blaine fineness is determined as provided in the standard EN 196. The Blaine fineness may refer to the combination of the several components ground individually or to the result of a co-ground of all the components. In addition, the Blaine fineness of the cement thereby corresponds to a specific ground surface of the cement.

In a first embodiment of the method of the present invention, of which results a first embodiment of the cement of the present invention, it comprises 95% low-carbon clinker and 5% calcium sulphate. In an embodiment in which the pozzolanic materials, such as calcined clay, have a concentration of 30% w/w in the low-carbon clinker, the presence of calcined clay in the cement is thereby of 28.5% w/w.

In a second embodiment of the method of the present invention, of which results a second embodiment of the cement of the present invention, it comprises 5% low-carbon clinker, 1-5% calcium sulphate (preferably 1% w/w) and 94% w/w of the additional element. The additional element may comprise a pozzolanic material, a blast furnace slag or another element. In an embodiment in which the pozzolanic materials, such as calcined clay, have a concentration of 30% w/w in the low-carbon clinker, the presence of calcined clay in the cement originating in the low-carbon clinker is thereby of 1.5% w/w.

In a third embodiment of the method of the present invention, of which results a third embodiment of the cement of the present invention, it comprises 60% low-carbon clinker, 5% calcium sulphate, 20% w/w limestone and 15% w/w of the additional element, preferably pozzolanic materials. In an embodiment in which the pozzolanic materials, such as calcined clay, have a concentration of 30% w/w in the low-carbon clinker, the presence of calcined clay in the cement originating in the low-carbon clinker is thereby of 20% w/w. Thus, for an additional element consisting of calcined clay, the overall concentration of calcined clay in the cement is of 35% w/w.

### EXAMPLES

### Example 1—Low-Carbon Clinker Using Calcined Clays

In a traditional line, when the production is optimized to maximize the quality of the produced clinker, i.e. preferably a flour which allows obtaining C₃S contents in the clinker above 60%, it will be possible to introduce in the cooler about 15% to 20% of kaolinite clays whose thermal processing requires temperatures around 800° C., previously determined by a thermal gravimetric analysis and DTA.

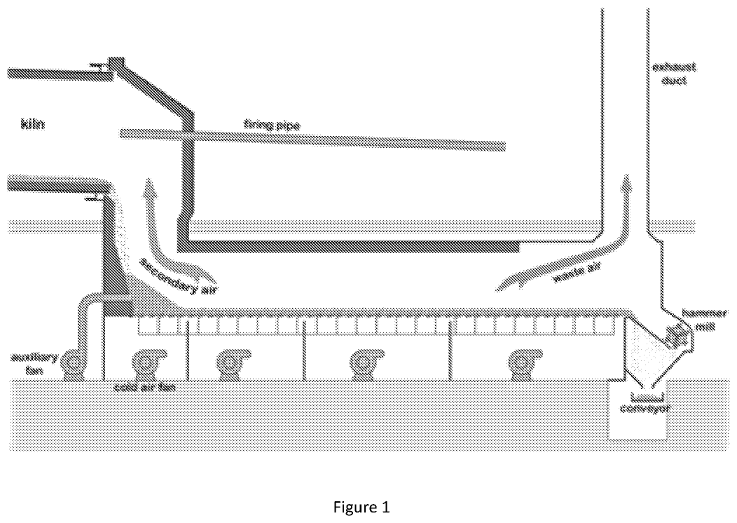

Once the characteristics of the materials to incorporate were analyzed, the dosing takes place in the cooler head according to FIG. 1. The specific consumption of thermal energy of the clinker thus formed is lowered by about at least 15%.

The mineralogical composition of mono-silicates which form in the introduction undergoes a change at this stage. The chemical analysis indicates an increase of the silica contents and a decrease of calcium oxide contents. The reactivity does not change significantly, with a loss in resistance less than 5% after 1 day, and 98% of the clinker without any change after 28 days. The process control follows the usual rules through XRF and XRD.

| | | | | | | Na₂O eq | | | Free | Lost at | Insoluble |
|---|---|---|---|---|---|---|---|---|---|---|---|
| | SiO₂ | Al₂O₃ | Fe₂O₃ | CaO | MgO | (1) | Cl | SO₃ | lime | fire | residue |
| Typical | 21.28 | 4.80 | 3.50 | 65.20 | 1.98 | 0.80 | 0.06 | 1.83 | 1.60 | 1.90 | 1.22 |
| Portland | | | | | | | | | | | |
| clinker | | | | | | | | | | | |
| Low-CO₂ | 27.63 | 11.17 | 3.01 | 52.65 | 1.63 | 0.97 | 0.05 | 1.52 | 1.29 | 1.99 | 14.76 |
| clinker | | | | | | | | | | | |

The low-carbon clinker which is therefrom obtained is added at least one additional component, wherein:
the at least one additional component comprises a pozzolanic material, a fly ash, limestone, a blast furnace slag, silica fume, schist and/or their combinations, and
the low-carbon clinker is added in a concentration of 15-35% weight/weight (w/w), thereby obtaining the low-carbon cement.

### Example 2—Low-Carbon Clinker Using Bottom Ash or Fly Ash with High Unburned Content (12%)

Introduction of 18% to 20% of bottom ash or fly ash in the cooler with high unburned content, whose thermal processing requires temperatures around 200° C. previously determined by a thermal gravimetric analysis and DTA.

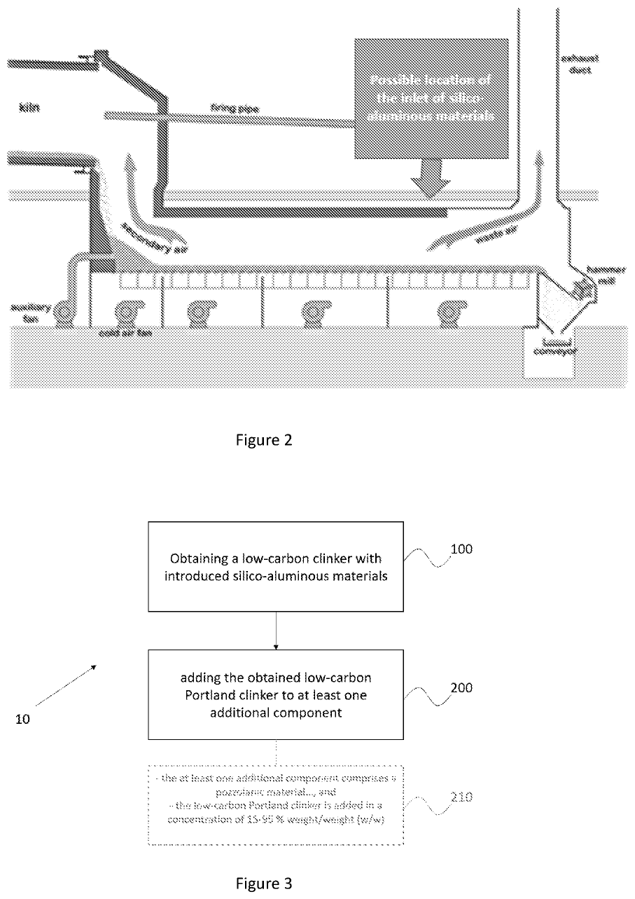

Once the characteristics of the material were analyzed, the dosing takes place in the grate type cooler, according to FIG. 2. The specific consumption of thermal energy of the clinker thus formed is lowered by about 18% in this situation, depending on the moisture contents of the material.

The mineralogical composition of mono-silicates which form in the introduction undergoes a change at this stage. The reactivity does not change significantly, with a loss in resistance less than 7% after 1 day, and 95 to 98% of the clinker without any change after 28 days.

The process control follows the usual XRF and XRD analysis.

| | | | | | | Na₂O eq | | | Free | Lost at |
|---|---|---|---|---|---|---|---|---|---|---|
| | SiO₂ | Al₂O₃ | Fe₂O₃ | CaO | MgO | (1) | Cl | SO₃ | lime | fire |
| Typical | 21.28 | 4.80 | 3.50 | 65.20 | 1.98 | 0.80 | 0.06 | 1.83 | 1.60 | 1.90 |
| Portland | | | | | | | | | | |
| clinker | | | | | | | | | | |
| Low-CO₂ | 24.29 | 6.10 | 7.94 | 54.66 | 1.70 | 1.13 | 0.05 | 1.74 | 1.31 | 1.88 |
| clinker | | | | | | | | | | |

The low-carbon clinker which is therefrom obtained is added at least one additional component, wherein:
the at least one additional component comprises a pozzolanic material, a fly ash, limestone, a blast furnace slag, silica fume, schist and/or their combinations, and
the low-carbon clinker is added in a concentration of 15-90% weight/weight (w/w), preferably 15-35% w/w, or 20-25% w/w, or even in a concentration of 20% w/w, thereby obtaining the low-carbon cement.

As will be clear to one skilled in the art, the present invention should not be limited to the embodiments described herein, and a number of changes are possible which remain within the scope of the present invention.

Of course, the preferred embodiments shown above are combinable, in the different possible forms, being herein avoided the repetition all such combinations.

1. A method for producing a low-carbon cement characterised in that it comprises the following steps:
obtaining a low-carbon clinker, the low-carbon clinker being obtained by the following steps:
i. for a raw material comprising limestone, pre-calcination of such limestone in the raw material;
ii. start of a clinkering process with a pre-calcined raw material, thereby obtaining an intermediate material;
iii. cooling the intermediate material;
iv. introduction of silico-aluminous materials and mixing with the intermediate material at a cooler head, such introduction being performed by a dosing conveyor and buffered by a double-inlet valve, and
thereby obtaining a low-carbon clinker,
adding the obtained low-carbon clinker in a concentration of 5-95% weight/weight (w/w) to calcium sulphate, thereby obtaining the low-carbon cement.

2. A method according to claim 1 wherein it further comprises the addition of at least one additional component to the low-carbon clinker and calcium sulphate, wherein:
the at least one additional component comprises a pozzolanic material, a carbonate component, a blast furnace slag, silica fume, burnt shale and/or their combinations.

3. A method according to claim 1 wherein the calcium sulphate is present in a proportion of 0.1-10% w/w, more preferably 0.1-5% w/w, even more preferably 0.1-3% w/w or 0.5-3% w/w.

4. A method according to claim 1 wherein the low-carbon clinker is added in a concentration of 5-95%, more preferably 5-20% w/w, 20-50% w/w, 50-70% w/w or 70-95% w/w.

5. A method according to claim 2 wherein the additional component is added in a concentration of 6-94% w/w.

6. A method according to claim 2 wherein it further comprises the addition of Portland clinker to the low-carbon clinker and the at least one additional component.

7. A method according to any of the claim 2 wherein the additional component comprises a carbonate component, optionally consisting of a natural material, a waste product or a combination thereof, wherein the carbonate component optionally consists of limestone, magnesium carbonate, calcium magnesium carbonate or combinations thereof and is present in a concentration of 0.1-30% w/w, more preferably 10-20% w/w.

8. (canceled)

9. (canceled)

10. A method according to any of the claim 2 wherein the additional component comprises a pozzolanic material, the pozzolanic material consisting of fly ash, calcined clay, bottom ash, another natural or artificial silica-aluminous material, or combinations thereof.

11. A method according to claim 10, wherein the pozzolanic material comprises calcined clay, preferably natural calcined clay.

12. A method according to claim 1, wherein it further comprises the addition of an additional inorganic mineral to the low-carbon clinker and to the additional component, the additional inorganic mineral comprising an additive, such as a pigment or an activator.

13. A method according to claim 12 wherein the additional inorganic mineral comprises an activator, the activator being added when of the agglomeration of cement.

14. A method according to claim 13 wherein the additional inorganic mineral comprises an activator, the activator comprising strongly alkaline materials, such as sodium hydroxide, potassium hydroxide, calcium hydroxide, calcium oxide, calcium nitrate, potassium nitrate or sodium silicate.

15. A method according to claim 14 wherein it is present in a concentration within a range of 0.1-20% w/w, more preferably 0.1-15% w/w.

16. A method according to claim 1, wherein it further comprises the addition of an additional organic mineral to the low-carbon clinker and to the additional component, the additional organic mineral comprising a grinding aid or an admixture, the grinding aid preferably comprising a tensioactive composition and/or the admixture preferably comprising a plasticizer, a superplasticizer or a retarder.

17. A method according to claim 1 wherein the silico-aluminous materials are selected from:
blast furnace slag, clay, marl clays, shale, schist and combinations thereof, natural pozzolanas, diatomite and processed materials, such as artificial pozzolanas originated from waste or by-products of other industries, for instance fly ash, bottom ash, silica fumes or other by-products, or combinations thereof.

18. A method according to claim 1 wherein the pre-calcination of step i. is performed along a pre-calciner of a cyclone tower.

19. A method according to claim 1 wherein step ii. is performed at a temperature higher than 1400° C. and with a C₃S content above 60%.

20. A method according to claim 1 wherein, in step iv., the silico-aluminous materials are introduced in 5 to 30% w/w relative to the intermediate material.

21. A method according to claim 1 wherein the Blaine fineness of the cement is within the range of 2.500 to 12.000 cm²/g, preferably 3.600-5.500 cm²/g.

22. A low-carbon cement obtained by the method of claim 1.
